(19) United States
(12) Patent Application Publication
(10) Pub. No.: US 2009/0113798 A1
(43) Pub. Date: May 7, 2009

(54) SECURITY WINDOW

(75) Inventor: Nelson Nieves Zeno, Arroyo, PR (US)

Correspondence Address: CARTER, DELUCA, FARRELL & SCHMIDT, LLP, 445 BROAD HOLLOW ROAD, SUITE 420, MELVILLE, NY, 11747, US

(73) Assignee: World Engineering Solutions Corp., Arroyo, PR (US)

(21) Appl. No.: 12/261,119

(22) Filed: Oct. 30, 2008

Related U.S. Application Data
(60) Provisional application No. 61/001,754, filed on Nov. 2, 2007.

(51) Int. Cl. E06B 7/086; E06B 7/16

(52) U.S. Cl. 49/92.1; 49/476.1

(57) ABSTRACT

A security window for shielding a secured space against forceful attacks generally includes a lateral profile, a pane having outer and inner surfaces, a clamping assembly adapted to hold the pane, a column protruding from the lateral profile, and a first seal disposed longitudinally along the column. The clamping assembly is rotatably coupled to the lateral profile. In operation, the pane moves between closed and open positions upon rotation of the clamping assembly. The column spans longitudinally along the pane and the clamping assembly. The first seal is adapted to hinder fluid from passing through the pane and the clamping assembly and abuts the outer surface of the pane when the pane is located in the closed position.

### CROSS-REFERENCE TO RELATED APPLICATION

The present application claims priority to, and the benefit of, U.S. Provisional Patent Application Ser. No. 61/001,754, filed on Nov. 2, 2007, the entire contents of which are hereby incorporated by reference.

### BACKGROUND

1. Technical Field

The present disclosure relates to windows for stationary structures such as buildings and homes. More particularly, the present disclosure relates to security windows having impact-resistant properties.

2. Background of Related Art

Over the years, security windows have been developed for a number of purposes. Some security windows are specifically designed to impede forced entry or penetration by projectiles. Other security windows are capable of resisting hurricane force winds. Regardless of its specific objective, security windows usually provide a higher level of protection than regular windows.

A conventional security window includes a framework supporting reinforced panes. Typically, glass and plastic layers form the reinforced panes. Some of the reinforced panes have at least one plastic reinforcing layer and a number of glass layers. One type of security window uses a special laminate composed of a polycarbonate sheet, layers of tertiary butyl styrene resin, and at least one glass sheet. One layer of tertiary butyl styrene resin is adhered to each opposing side of the polycarbonate sheet. The glass sheets, in turn, are bonded to each layer of tertiary butyl styrene resin. A highly flexible silicone adhesive may be utilized to glue the laminate to a window frame.

Another kind of security window offers protection against incoming projectiles by utilizing a window pane with a gap and internal chambers. This window pane includes a frame composed of metallic profiled sections. The metallic profiled sections delimit the gap, which has a stepped configuration. In use, a projectile moving toward the window pane may enter the gap, but it is promptly deflected by the stepped configuration of the gap. The window pane also has internal chambers delimited by inclined surfaces that extend at an acute angle with respect to a side of the window pane. When a projectile penetrates any of these internal chambers, it is deflected upon contacting the inclined surfaces delimiting the respective internal chamber. After the projectile has been deflected, other parts of the window pane stop the penetrating projectile.

In addition to the window designs described above, many other designs have been developed throughout the years. Nonetheless, improvements are always possible.

### SUMMARY

The present disclosure relates to a security window for shielding a secured space against forceful attacks. The security window generally includes a lateral profile, a pane having outer and inner surfaces, a clamping assembly adapted to hold the pane, a column protruding from the lateral profile, and a first seal disposed longitudinally along the column. The clamping assembly is rotatably coupled to the lateral profile. In operation, the pane moves between closed and open positions upon rotation of the clamping assembly. The column spans longitudinally along the pane and the clamping assembly. The first seal is adapted to hinder fluid from passing through the pane and the clamping assembly and abuts the outer surface of the pane when the pane is located in the closed position.

The present disclosure further relates to a security window generally including a lateral profile, a plurality of panes each having outer and inner surfaces, a plurality of clamping assemblies each adapted to hold one pane of the plurality of panes, a column protruding from the lateral profile, and a first seal disposed longitudinally along the column. Each pane is selectively movable between open and closed positions. Each clamping assembly is rotatably coupled to the lateral profile. The column spans longitudinally along the plurality of panes and the plurality of clamping assemblies. Moreover, the column includes a channel adapted to drain fluid. The first seal is adapted to hinder fluid flow through the plurality of panes and the plurality of clamping assemblies and abuts the outer surface of each of the plurality of panes when the plurality of panes are located in the closed position.

### BRIEF DESCRIPTION OF THE DRAWINGS

Various embodiments of the presently disclosed security window are described herein with reference to the drawings, wherein:

FIG. 1 is a front perspective view of a security window in accordance with an embodiment of the present disclosure;

FIG. 2 is a rear perspective view of the security window of FIG. 1;

FIG. 3 is a side cross-sectional view of the security window of FIG. 1;

FIG. 4 is a top plan view of the security window of FIG. 1;

FIG. 5 is a front perspective view of the security window of FIG. 1 without a sill;

FIG. 6 is a side cross-sectional view of the security window of FIG. 1 without the sill;

FIG. 7 is perspective view of a lateral profile of the security window of FIG. 1;

FIG. 8 is a rear perspective view of the security window of FIG. 1 with a seal partially positioned in the lateral profile;

FIG. 9 is a rear perspective view of the security window of FIG. 1 with the entire seal positioned in the lateral profile;

FIG. 10 is a rear perspective view of the security window of FIG. 1 without a seal positioned in the lateral profile;

FIG. 11 is a rear perspective view of a clamping assembly and a pane of the security window of FIG. 1;

FIG. 11A is a top cross-sectional view of a portion of the security window of FIG. 1;

FIG. 12 is an exploded rear perspective view of the clamping assembly and pane of FIG. 11;

FIG. 13 is a side cross-sectional view of the clamping assembly and pane of FIG. 11;

FIG. 14 is a front perspective view of the security window of FIG. 1 with the panes partially opened;

FIG. 15 is a rear perspective view of the security window of FIG. 1 with the panes partially opened;

FIG. 16 is a side cross-sectional view of the security window of FIG. 1 with the panes partially opened;

FIG. 17 is rear perspective view of the security window of FIG. 1 showing the panes more open than in FIG. 15;

FIG. 18 is a rear perspective view of the security window of FIG. 1 without a sill or a header showing the panes partially opened; and

FIG. 19 is a rear perspective view of the security window of FIG. 1 with the panes fully open.

### DETAILED DESCRIPTION OF THE EMBODIMENTS

Embodiments of the presently disclosed security window will now be described in detail with reference to the drawings in which like reference numerals designate identical or corresponding elements in each of the several views. Throughout this disclosure, the term “outer” refers to the side of the window subject to a forceful attack by natural elements or humanly created threats, while the term “inner” refers to the side of the window facing a secured space.

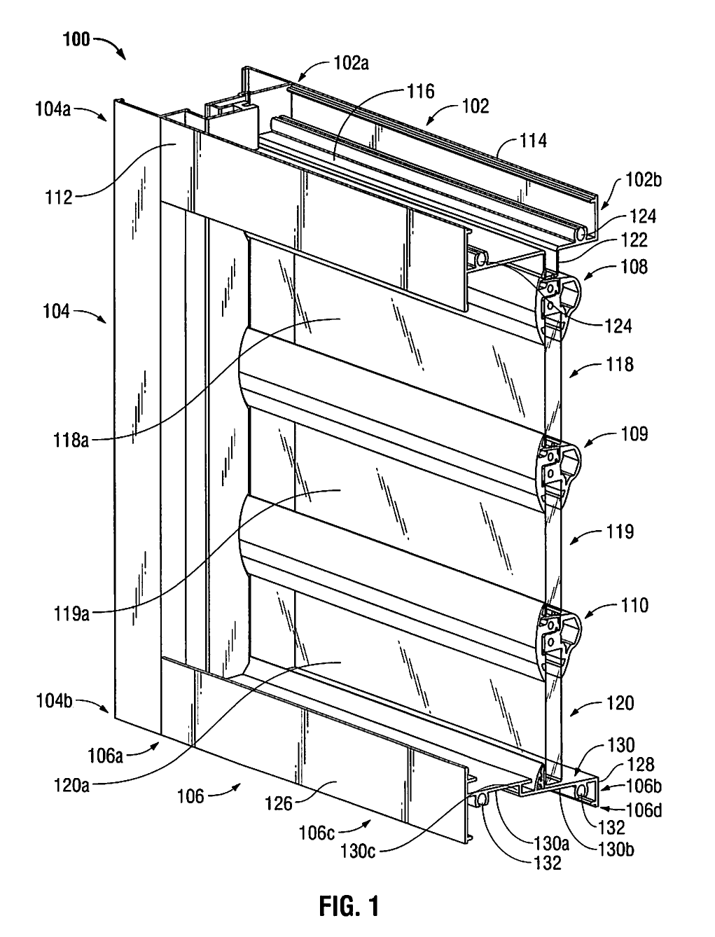

Referring to FIGS. 1-4, an embodiment of the presently disclosed security window is designated as 100. Generally, security window 100 includes a header 102, at least one jamb or lateral profile 104, a sill 106, a plurality of clamping assemblies 108, 109, 110, and a plurality of panes 118, 119, 120. In the embodiment illustrated in FIG. 1, header 102, two lateral profiles 104 (only one is shown), and sill 106 together enclose clamping assemblies 108, 109, 110 and panes 118, 119, 120. Lateral profiles 104 support clamping assemblies 108, 109, 110. In turn, each clamping assembly 108, 109, 110 holds a corresponding pane 118, 119, 120 and is rotatably mounted to at least one lateral profile 104. In the depicted embodiment, a first clamping assembly 108 holds a first pane 118, a second clamping assembly 109 holds a second pane 119, and a third clamping assembly 110 holds a third pane 120. Although three panes and clamping assemblies are illustrated, it is contemplated that the presently disclosed security window may include more or fewer than panes and clamping assemblies. Panes 118, 119, 120 may be made of plastic, glass, or any suitable material. In addition, header 102 has first and second ends 102a, 102b and each end 102a, 102b is operatively connected to a lateral profile 104. Sill 106 has first and second ends 106a, 106b and each end 106a, 106b is operatively coupled to a lateral profile 104. Each lateral profile 104 also has first and second end 104a, 104b connected to header 102 and sill 106, respectively. In particular, each first end 104a of each lateral profile 104 is secured to a corresponding end (102a or 102b) of header 102, whereas each second ends 104b of each lateral profile 104 is fixed to a corresponding end (106a or 106b) of sill 106.

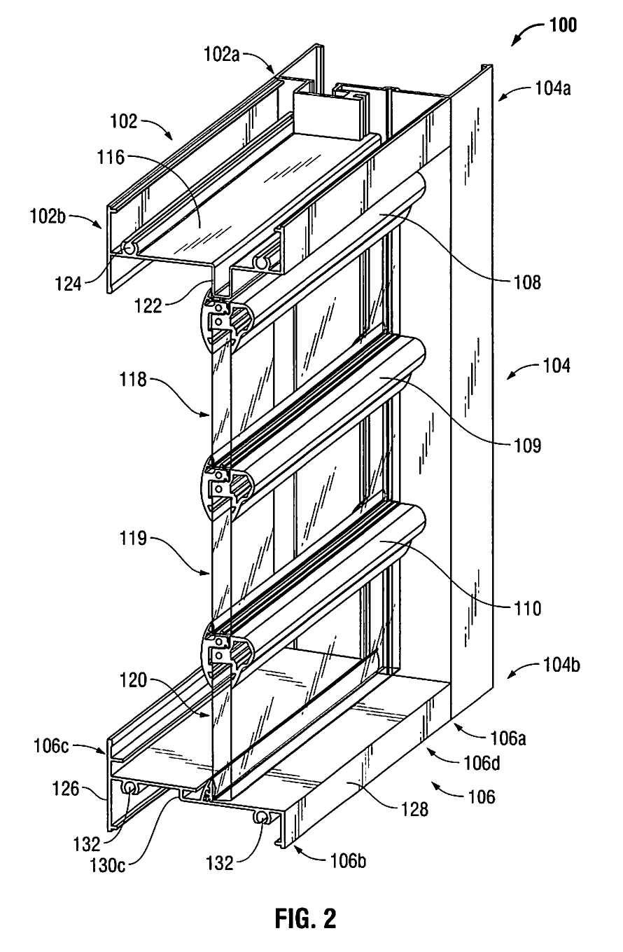

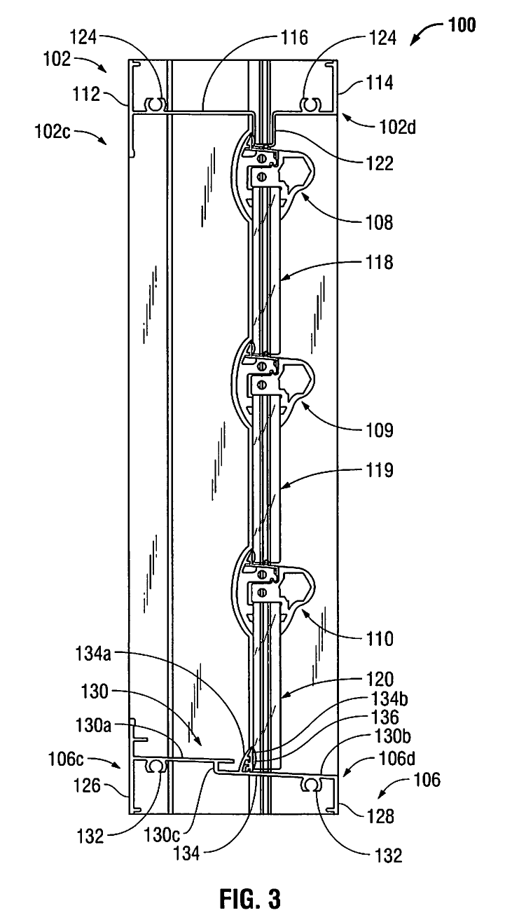

Header 102 is disposed adjacent to first clamping assembly 108 and includes an outer panel 112, an inner panel 114, and a connecting panel 116 interconnecting outer panel 112 and inner panel 114. As illustrated in FIG. 3, outer panel 112 is positioned on an outer portion 102c of header 102, while inner panel 114 is located on inner portion 102d of header 102. Connecting panel 116 is transversely coupled to outer panel 112 and inner panel 114 and includes a groove 122 and at least one engagement portion 124. Groove 122 extends toward first clamping assembly 108 and is partially positioned on an inner portion of first clamping assembly 108 when security window 100 is in the closed position, as shown in FIG. 2. In the embodiment shown in FIG. 3, connecting panel 116 has two engagement portions 124. Each engagement portion 124 has substantially hemispherical shape and extends longitudinally along the length of connecting panel 116. When the security window 100 is mounted to a stationary structure, engagement portions 124 facilitate the connection between header 102 and the stationary structure.

Still 106 is positioned adjacent to third pane 120 and has an outer panel 126, an inner panel 128, and a connecting panel 130 interconnecting outer panel 126 and inner panel 128. Outer panel 126 is located on an outer portion 106c of sill 106, whereas inner panel 128 is positioned on an inner portion 106d of sill 106. Connecting panel 130 is transversely secured to outer panel 126 and inner panel 128 and has a first section 130a and a second section 130b arranged in a stepped configuration. A supporting wall 130c interconnects first and second sections 130a, 130b. A portion of first section 130a extends toward third pane 120 and overlaps a portion of second section 130b. First and second sections 130a, 130b each have an engagement portion 132 for facilitating the connection between sill 106 and a stationary structure. In the embodiment shown in FIG. 3, each engagement portion 132 has substantially hemispherical shape and extends longitudinally along the length of first and second sections 130a, 130b, respectively. The present disclosure, however, envisions engagement portions having any suitable shape insofar as such engagement portions facilitate the connection between sill 106 and a stationary structure.

In addition to engagement portion 132, second section 130b of sill 106 contains an abutment wall 134 protruding transversely therefrom, as illustrated in FIG. 3. Abutment wall 134 extends toward header 102 and includes an outer surface 134a, an inner surface 134b, and a seal 136 positioned along the length of inner surface 134a. Outer surface 134a of abutment wall 134 protects a lower portion of third pane 120, and seal 136, which is disposed on inner surface 134a, abuts said lower portion of third pane 120 when security window 100 is located in the closed position. In certain embodiments, outer surface 134a has a curved profile. Seal 136 minimizes or prevents passage of water or any other fluids through security window 100.

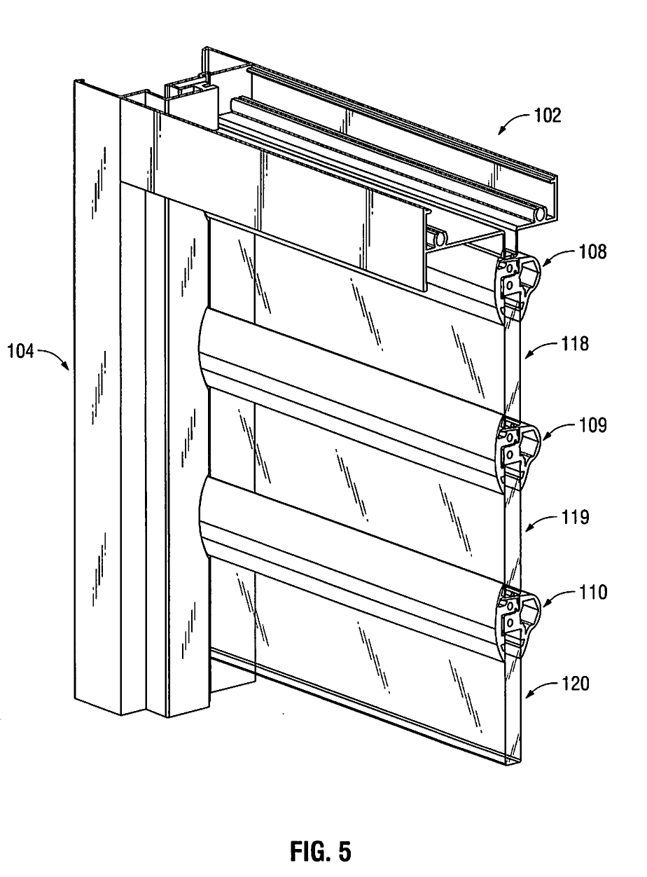

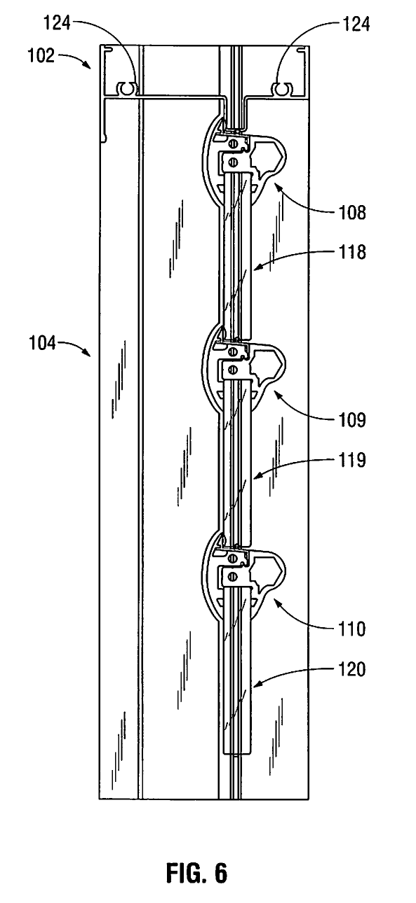

With reference to FIGS. 5 and 6, an embodiment of security window 100 includes all the components described hereinabove except for the sill 106. Alternatively, this embodiment may utilize another kind of sill. It is envisioned that security window 100 may include any suitable sill so long as it can be operatively attached to lateral profile 104 and facilitate attachment of the security window 100 to a stationary structure.

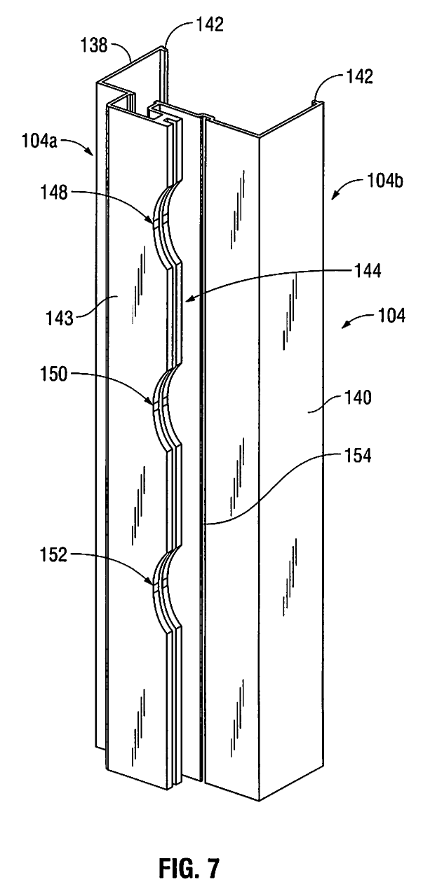

Regarding FIGS. 7-10, security window 100 includes a right lateral profile 104 and a left lateral profile (not shown). Left lateral profile is a mirror image of right lateral profile 104. Since the construction and operation of right lateral profile 104 and left lateral profile are substantially similar, the present disclosure will only discuss the construction and operation of right lateral profile 104. Right lateral profile 104 includes an outer board 138 positioned on an outer portion 104a and an inner board 140 located on an inner portion 104b. Each board 138, 140 has a protrusion 142 for facilitating engagement with a stationary structure. Lateral profile 104 further includes a column 143 protruding toward panes 118, 119, 120 and spanning along clamping assemblies 108, 109, 110 and panes 118, 119, 120 and clamping assemblies such that part of column 143 covers an outer portion of panes 118, 119, 120. Column 143 has a plurality of concave sections 148, 150, 152 for receiving portions of clamping assemblies 108, 109, 110 as seen in FIG. 7. Moreover, column 143 defines a longitudinal channel 144 therealong. Overall, lateral profile 104 may be made of aluminum or any other suitable material.

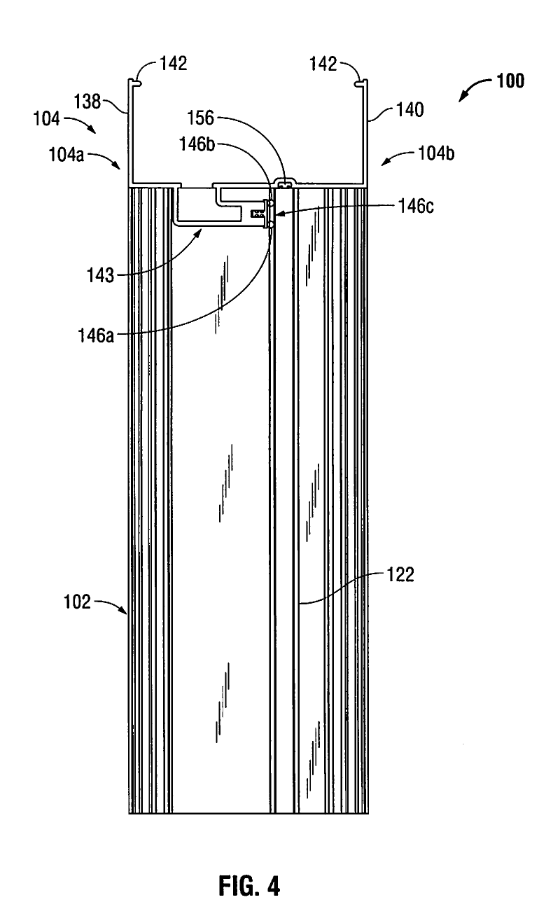

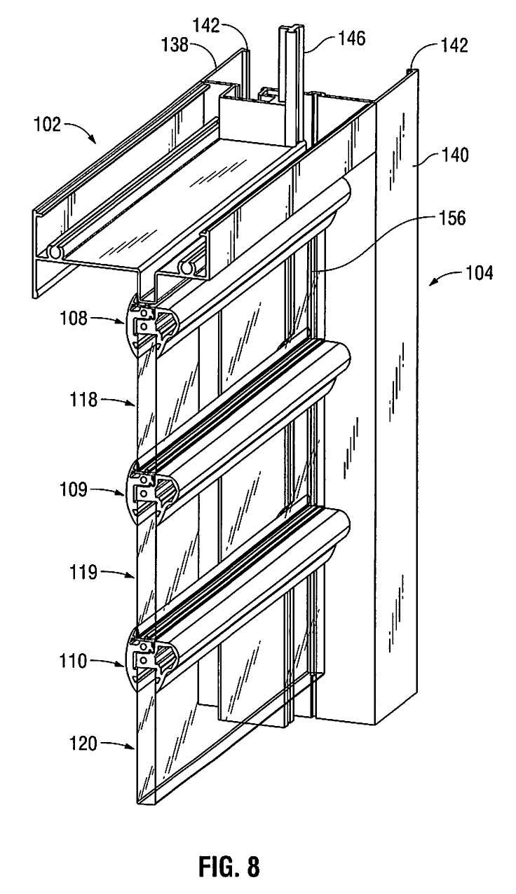

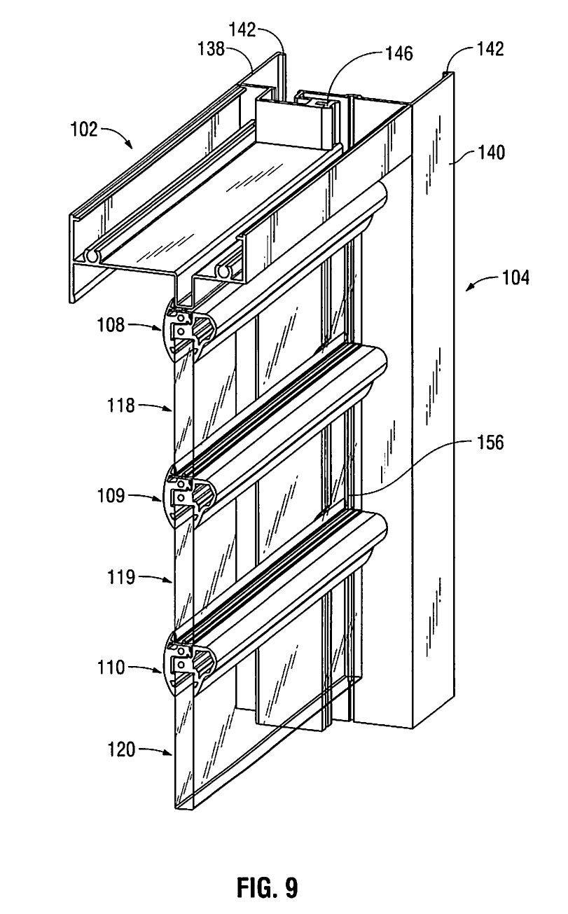

Channel 144 of column 143 is adapted to receive a first longitudinal seal 146 as illustrated in FIG. 8. First longitudinal seal 146 can be inserted into column 143 by sliding first longitudinal seal 146 through channel 144. Once the first longitudinal seal 146 has been inserted in column 143, first longitudinal seal 146 lies along substantially the entire length of channel 144 and contacts the outer surfaces of clamping assemblies 108, 109, 110 and panes 118, 119, 120, as depicted in FIGS. 4 and 9.

With reference to FIG. 4, first longitudinal seal 146 may be an airtight seal, a watertight seal, or any other suitable seal. In one embodiment, first longitudinal seal 146 includes first and second seal portions 146a, 146b positioned along the length of the first longitudinal seal 146. First and second seal portions 146a, 146b are positioned substantially parallel to each other and each has a substantially cylindrical shape. Second seal portion 146b is located closer to lateral profile 104 than first seal 146a. Both seal portions 146a, 146b contact the outer surfaces of clamping assemblies 108, 109, 110 and panes 118, 119, 120 and minimize the possibility of fluids entering through security window 100. Specifically, first seal portion 146a protects security window 100 from outer wind and water pressures, while second seal portion 146b protects security window 100 from leaks from the first seal portion 146a. Any water leaks contained by second seal portion 146b is drained through a safe channel 146c defined between first and second seal portions 146a, 146b, thereby reducing the risk of water stagnation inside security window 100.

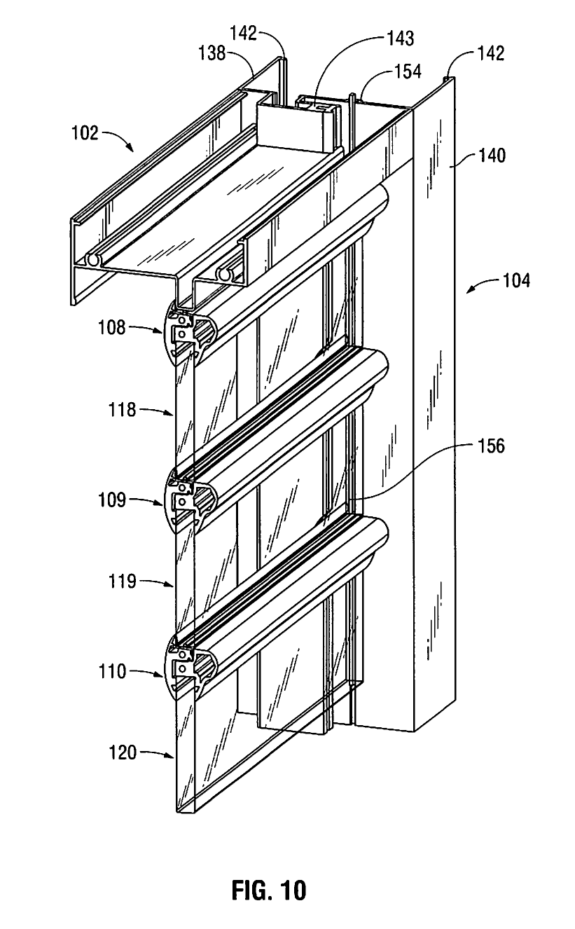

Referring again to FIGS. 7-10, lateral profile 104 also includes a longitudinal recess 154 configured to receive a second longitudinal seal 156. Second longitudinal seal 156, which is positioned along longitudinal recess 156, minimizes the possibility of water or air passing through security window 100. The present disclosure envisions that second longitudinal seal 156 may be an airtight seal, a watertight seal, or any other suitable seal. As seen in FIGS. 9 and 10, second longitudinal seal 156 contacts lateral surfaces of clamping assemblies 108, 109, 110 and panes 118, 119, 120, thereby protecting the area between the lateral profile 108 and panes 118, 119, 120.

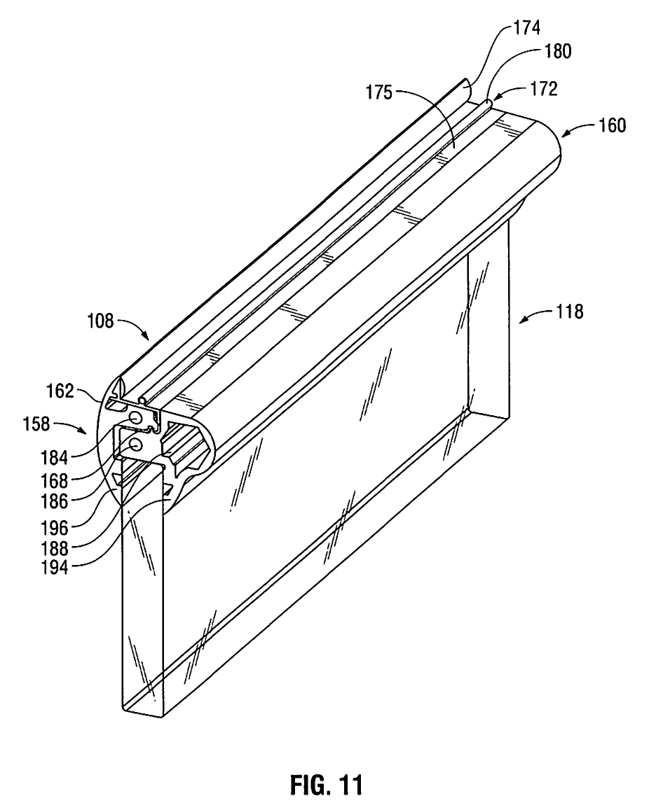

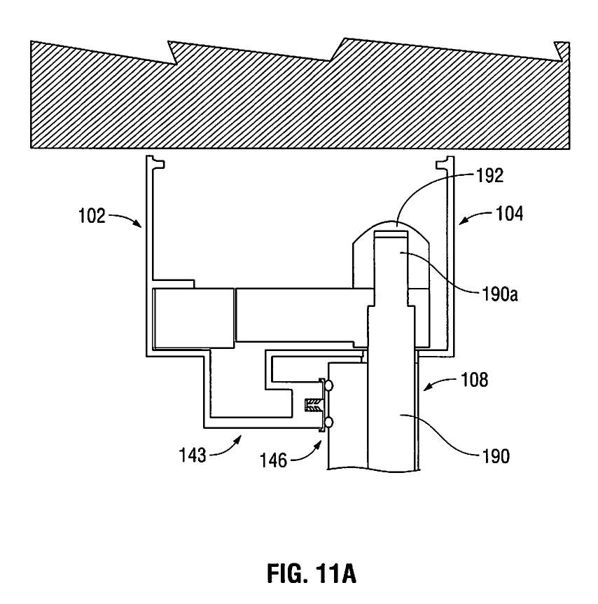

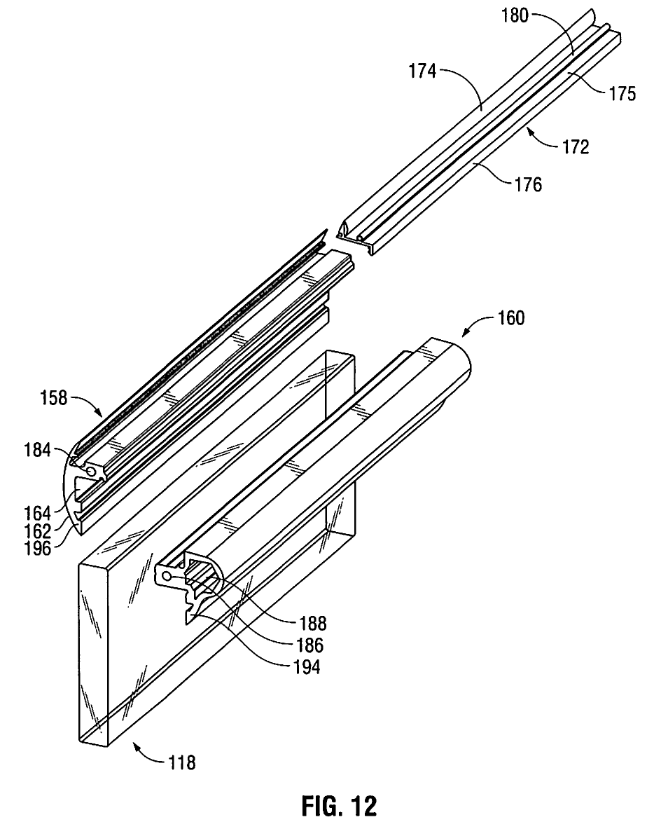

With reference to FIGS. 11-13, each clamping assembly 108, 109, 110 is configured to hold a corresponding pane 118, 119, 120. Since the construction and operations of all the clamping assemblies 108, 109, 110 is substantially identical, the present disclosure will only describe the construction and operation of first clamping assembly 108. The first clamping assembly 108, which retains pane 108, has an outer section 158 and an inner section 160. Outer section 158 and inner section 158 are operatively connected to each other and together hold pane 118. Outer section 158 includes an outer surface 162 having a convex shape. During use, outer surface 162 shields security window 100 against forceful attacks. Although the drawings show an outer surface 162 having a convex shape, the present disclosure contemplates that outer surface 162 of outer section 158 may have any suitable configuration.

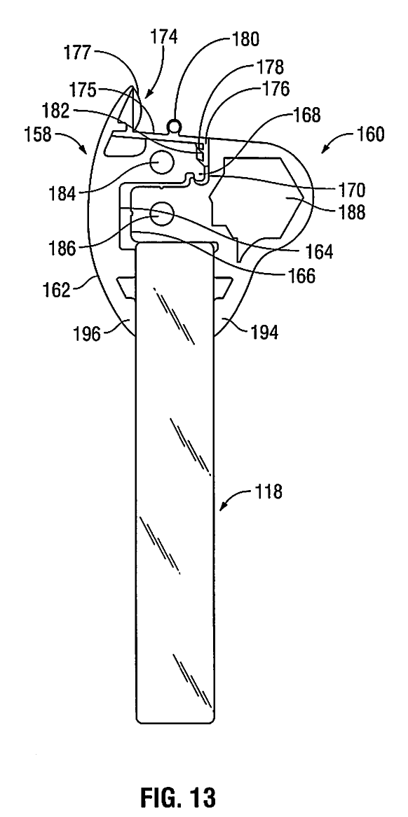

Outer section 158 further includes an inner surface 164 that is substantially complementary to an inner surface 166 of inner section 160. Inner surface 164 of outer section 158 includes an engagement protrusion 168 adapted to be positioned in an engagement recess 170 of inner surface 166 of inner section 160, as seen in FIG. 13.

In addition, a seal 172 is operatively connected to inner surface 164 of outer section 158. Seal 172 extends along substantially the entire length of inner surface 164 and includes a flap 174 having a convex profile, a connecting surface 176 having a plurality of teeth 178 and transverse portion 175 interconnecting flap 174 and connecting surface 176. A longitudinal seal portion 180 having a cylindrical shape is mounted along transverse portion 175. Flap 174 abuts a portion of inner surface 164 and, in use, an inner surface 177 of flap 174 contacts a lower portion of a pane (118, 119, or 120) when the panes 118, 119, 120 are in the closed position as seen in FIG. 1. Connecting surface 176 is positioned within an axial space 182 defined between outer section 158 and inner section 160 and facilitates the connection of seal 172 and clamping assembly 108. Flap 174 and seal portion 180 of seal 172 hinder infiltration of water and air through clamping assembly 108.

Outer section 158 of clamping assembly 108 further includes a bore 184 positioned therethrough. First bore 184 is adapted to receive a rod (not shown). Similarly, inner section 160 includes a bore 186 positioned therethrough and configured to receive a rod (not shown). Inner section 160 has a longitudinal bore 188 extending therethrough. Longitudinal bore 188 is designed to receive a reinforced bar 190. (See FIG. 11A). Reinforced bar 190 provides security window 100 additional impact-resistant capabilities. Although reinforced bar 190 may be made by any suitable means, an embodiment of reinforced bar 190 is made using computer numerical control (CNC) machining techniques. In the embodiment depicted in FIG. 11A, reinforced bar 190 has ends 190a operatively connected to a bar support 192 located within lateral profile 102. Reinforced bar 190, or parts thereof, may be made of aluminum or any other suitable material. The shape of reinforced bar 190 matches the shape of longitudinal bore 188. The depicted longitudinal bore 188 has a polygon-shaped cross-section. Nonetheless, the present disclosure contemplates longitudinal bores with other suitable configurations.

Aside from longitudinal bore 188, inner section 160 has a clamping jaw 194. Outer section 158 also has a clamping jaw 196. Clamping jaws 194, 196 jointly hold pane 118. Frictional forces between clamping jaws 194, 196 and pane 118 maintain pane 118 securely attached to clamping assembly 108.

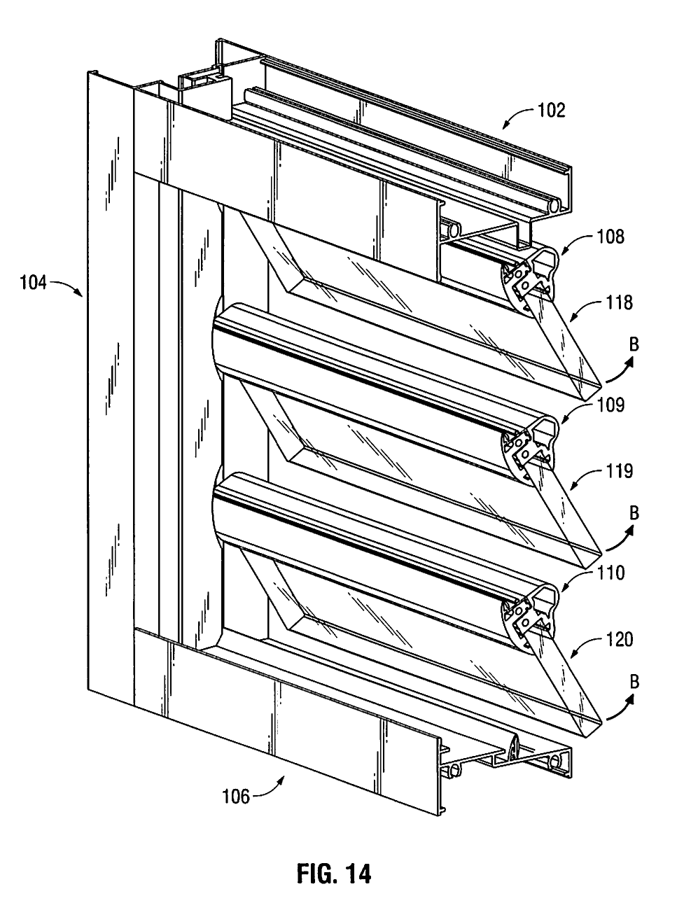

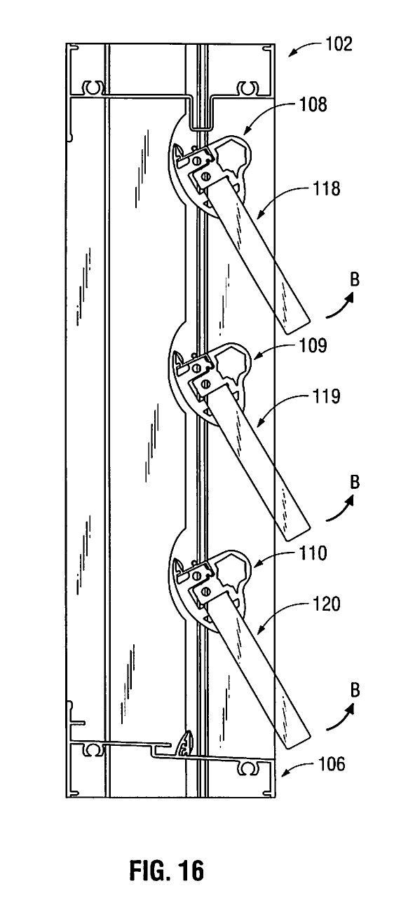

With reference to FIGS. 14-19, clamping assemblies 108, 109, 120 are capable of moving from a closed position (see FIG. 1) to a fully open position (see FIG. 20). Since each clamping assembly 108, 109, 110 is operatively connected to a reinforced bar 190, the rotation of a reinforced bar 190 causes the rotation of clamping assemblies 108, 109, 110. When clamping assemblies 108, 109, 110 rotate, each pane 118, 119, 120 pivot about an axis of the corresponding clamping assembly 108, 109, 110. The reinforced bars 190 may be operatively associated with one another such that the rotary motion of one reinforced bar 190 results in the rotation of all claming assemblies 108, 109, 110. Alternatively, reinforced bars 190 may be independently connected to the respective clamping assembly 108, 109, 110 such that a particular clamping assembly (108, 109, or 110) rotates upon rotation of the reinforced bar 190 operatively associated therewith. Reinforced bars 190 can be rotated manually through a gear system or any other suitable means. A motor, however, may be employed to rotate the reinforced bars 190.

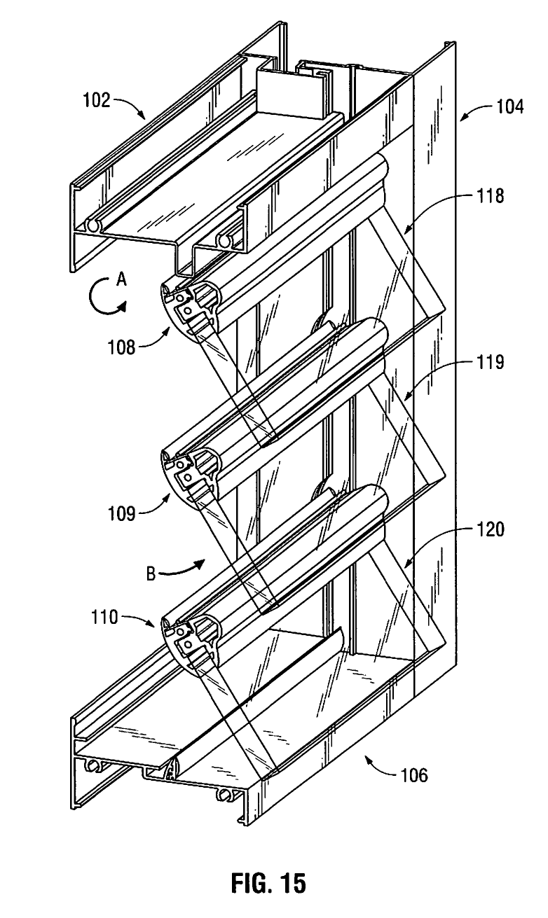

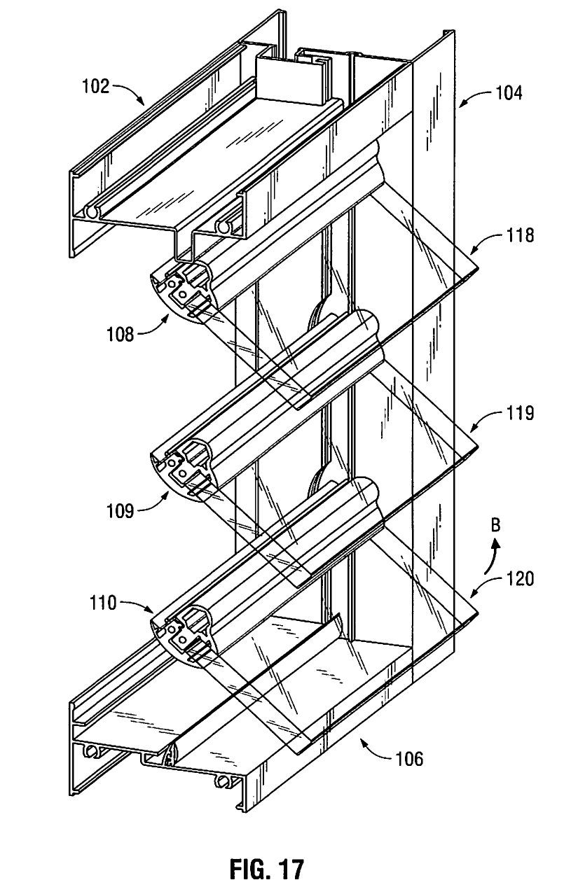

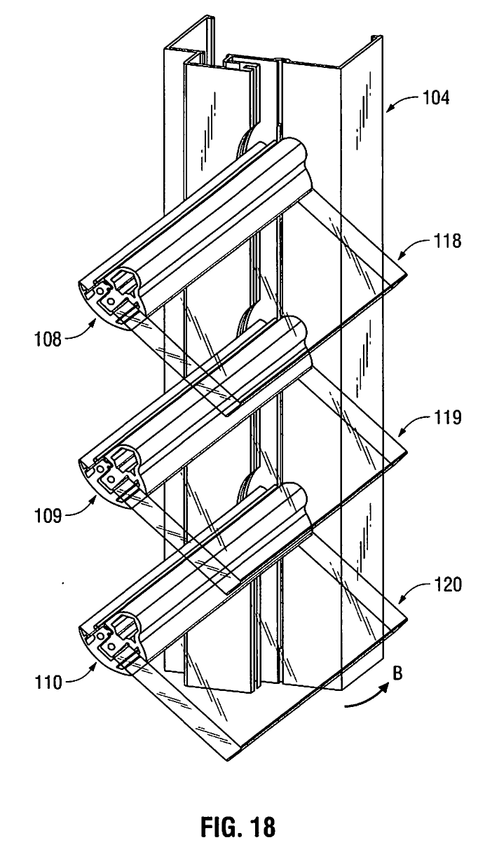

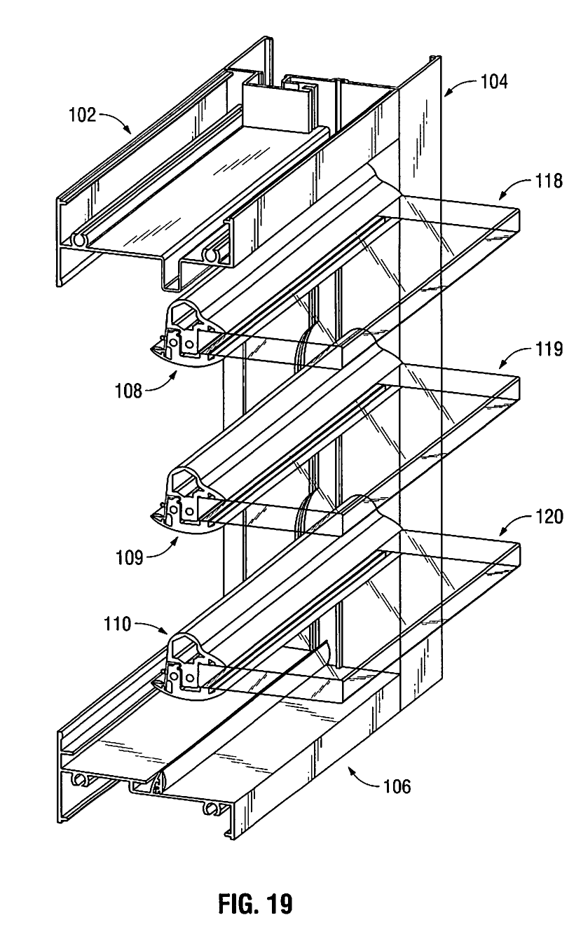

In the closed position, the outer surfaces 118a, 119a, 120a of panes 118, 119, 120 face an outer direction, as shown in FIG. 1. To place panes 118, 119, 120 in the open position, a user rotates reinforced bars 190 in a direction indicted by arrow “A” as shown in FIGS. 15 and 18. As reinforced bars 190 rotate, clamping assemblies 108, 109, 110 rotate in the direction indicated by arrow “A.” The rotation of clamping assemblies 108, 109, 110 causes panes 118, 119, 120 to pivot about the corresponding clamping assemblies 108, 109, 110 toward the direction indicated by arrows “B,” as illustrated in FIGS. 14-16. The continued rotation of reinforced bars 190 further rotates clamping assemblies 108, 109, 110, thereby moving panes 118, 119, 120 to the position shown in FIGS. 17 and 18. Eventually, further rotation of reinforced bars 190 rotate clamping assemblies 108, 109, 110 and position panes 118, 119, 120 in a fully open position, as depicted in FIG. 19.

It will be understood that various modifications may be made to the embodiments disclosed herein. Therefore, the above description should not be construed as limiting, but merely exemplifications of embodiments. Those skilled in the art will envision other modifications within the scope and spirit of the present disclosure.

What is claimed is:

1. A security window comprising:
a lateral profile;
a pane having outer and inner surfaces;
a clamping assembly adapted to hold the pane, the clamping assembly rotatably coupled to the lateral profile, wherein the pane is configured to move between closed and open positions upon rotation of the clamping assembly;
a column protruding from the lateral profile, the column extending longitudinally along the pane and the clamping assembly; and
a first seal disposed longitudinally along the column and adapted to hinder fluid from passing through the pane and the clamping assembly, wherein the first seal abuts the outer surface of the pane when the pane is located in the closed position.

2. The security window according to claim 1, wherein the clamping assembly includes outer and inner sections operatively coupled to each other, the inner section including a longitudinal bore extending therethrough.

3. The security window according to claim 2, further comprising a reinforced bar positioned in the longitudinal bore of the clamping assembly, wherein the reinforced bar is rotatably coupled to the clamping assembly.

4. The security window according to claim 1, wherein the first seal includes first and second portions oriented substantially parallel with respect to each other, the first portion being farther from the lateral profile than the second portion.

5. The security window according to claim 4, wherein the column defines a channel positioned between the first and second portions of the first seal, the channel being configured to drain fluid disposed between the first and second portions of the first seal.

6. The security window according to claim 1, wherein the lateral profile includes a recess formed thereon and a second seal disposed on the recess.

7. The security window according to claim 2, further comprising a third seal at least partially disposed on an inner surface of the inner section of the clamping assembly.

8. The security window according to claim 7, wherein the third seal includes a flap abutting the inner surface of the inner section of the clamping assembly.

9. The security window according to claim 1, further comprising header including a groove extending toward the clamping assembly.

10. The security window according to claim 1, further comprising a sill including an abutment wall extending toward the clamping assembly, wherein the abutment wall abuts the pane when the pane is in the closed position.

11. A security window comprising:
a lateral profile;
a plurality of panes each having outer and inner surfaces, wherein each pane is selectively movable between open and closed positions;
a plurality of clamping assemblies each adapted to hold one pane of the plurality of panes, wherein each clamping assembly is rotatably coupled to the lateral profile;
a column protruding from the lateral profile, the column spanning longitudinally along the plurality of panes and the plurality of clamping assemblies, wherein the column includes a channel adapted to drain fluid; and
a first seal disposed longitudinally along the column and adapted to hinder fluid flow through the plurality of panes and the plurality of clamping assemblies, wherein the first seal abuts the outer surface of each of the plurality of panes when the plurality of panes are located in the closed position.

12. The security window of according to claim 11, wherein each clamping assembly includes outer and inner sections operatively connected to each other.

13. The security window according to claim 12, wherein the inner section of each clamping assembly includes a longitudinal bore extending therethrough.

14. The security window according to claim 13, further comprising a reinforced bar at least partially positioned within the longitudinal bore.

15. The security window according to claim 12, wherein the outer section of each clamping assembly includes an outer surface having a convex profile.

16. The security window according to claim 15, wherein the column includes a plurality of concave portions matching the convex profile of the outer surface of each outer section.

17. The security window according to claim 11, wherein the lateral profile includes a recess formed longitudinally thereon.

18. The security window according to claim 17, further comprising a second seal positioned along the recess of the lateral profile.

19. The security window according to claim 12, further comprising a third seal disposed along an inner surface of the outer section of each clamping assembly.

20. The security window according to claim 11, wherein the first seal includes first and second seal portions oriented substantially parallel relative to each other.
